(19) United States
(12) Patent Application Publication
(10) Pub. No.: US 2026/0277890 A1
(43) Pub. Date: Sep. 17, 2026

(54) PLATFORM FOR PERFORMING MULTI-STAGE DATA OPERATIONS

(71) Applicant: Target Brands, Inc., Minneapolis, MN (US)

(72) Inventors: Caleb Walch, Minneapolis, MN (US); Adam Kendall Tremarche, Worcester, MA (US); Anthony Lim, Chanhassan, MN (US)

(21) Appl. No.: 19/077,551

(22) Filed: Mar. 12, 2025

(51) Int. Cl. G06F 16/2452; G06F 16/2458

(52) U.S. Cl. CPC G06F 16/24526; G06F 16/2458

(57) ABSTRACT

In some implementations, a method for chaining data operations includes receiving a definition of a multi-stage data operation that is expressed in a user-facing syntax, translating the user-facing syntax into an intermediate syntax, and parsing the intermediate syntax, to identify a series of data operations. Execution of the series of data operations is coordinated by a data processing platform, through operation handlers. In response to identifying an output variable that indicates output of a data operation, the data processing platform maps a portion of a data cache to the output variable. In response to identifying an input variable that indicates input for the data operation, the data processing platform retrieves data from a portion of the data cache that is mapped to the input variable, and provides the retrieved data to the selected operation handler. A result of the multi-stage data operation can be provided to a client device.

### TECHNICAL FIELD

This specification generally relates to a platform for performing multi-stage data operations that involve chaining data results from multiple different data sources, across a computer network.

### BACKGROUND

Data platforms are integrated suites of technologies that can facilitate the collection, storage, management, and analysis of large volumes of data. Such platforms typically include data warehouses, databases, and other storage systems to handle structured and unstructured data. The platforms often incorporate tools for data processing, transformation, and analytics. Data platforms generally ensure that data can be accessed and processed in real-time or on-demand.

### SUMMARY

This document generally describes computer systems, processes, program products, and devices for performing multi-stage data operations that involve chaining data results from multiple different data sources, across a computer network. In general, a multi-stage data operation (e.g., a multi-stage query) that has been defined in a user-facing syntax can be translated into an intermediate syntax (e.g., an abstract syntax tree (AST)) including a root node that represents a top-level query, and multiple child nodes that each represent subqueries to be executed. To perform the multi-stage data operation, an object expressed in the intermediate syntax (e.g., the AST) can be parsed by a data operation platform, which traverses the nodes of the object sequentially and identifies the various operations represented in the object. For each identified operation, the data operation platform determines the type of operation (e.g., a filter, a join, a function call, etc.), translates the portion of the object that corresponds to the operation into domain-specific syntax, and provides the domain-specific syntax to an operation handler that is configured to perform the operation on a specified data source. After each identified operation has been successfully performed, an overall result of the multi-stage data operation can be provided to a client computing device.

The data operation platform can also access a centralized cache in which results for each operation may be temporarily stored when executing an overall multi-stage data operation. The cached results are associated with an alias, which can be referenced by other operations, and can be provided to the operations through the data operation platform. Since an overall multi-stage data operation may involve accessing data across various different data sources, the results caching provides a mechanism for combining data from the data sources when determining a final result set based on the performed operations.

In some implementations, a method for chaining data operations includes: receiving, from a client device, a definition of a multi-stage data operation that is expressed in a user-facing syntax; translating the user-facing syntax of the multi-stage data operation into a definition of the multi-stage data operation that is expressed in an intermediate syntax; and parsing, by a data processing platform, the intermediate syntax of the multi-stage data operation, to identify a series of data operations included in the multi-stage data operation. Execution of the series of data operations included in the multi-stage data operation is coordinated by the data processing platform. For each data operation in the series of data operations, the data processing platform selects a respective operation handler that is configured to execute the data operation, the data processing platform generates domain-specific syntax that is used by the selected operation handler for executing the data operation, and the data processing platform provides to the selected operation handler, the domain-specific syntax for executing the data operation. For at least one data operation in the series of data operations, in response to identifying an output variable that indicates output of the data operation, the data processing platform maps a portion of a data cache to the output variable. For at least one data operation in the series of data operations, in response to identifying an input variable that indicates input for the data operation and that corresponds to the output variable of another data operation, the data processing platform retrieves data from a portion of the data cache that is mapped to the input variable, and provides the retrieved data to the selected operation handler. The method for chaining data operations further includes providing a result of the multi-stage data operation to the client device, after each data operation in the series of data operations has been successfully executed.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. The intermediate syntax can be formatted as an abstract syntax tree. Parsing the definition of the multi-stage data operation can include traversing nodes of the abstract syntax tree. Each operation can be defined in a respective node of the abstract syntax tree. Mapping the portion of the data cache to the output variable can include generating a cache key that references the portion of the data cache, and maintaining an association between the cache key and the output variable. The translating of the user-facing syntax can be performed at the client device. The translating of the user-facing syntax can be performed by the data processing platform. At least two of the operation handlers can be configured to execute data operations on different data platforms. At least two of the operation handlers can be configured to execute different types of data operations on a same data platform. The data processing platform can receive from a given operation handler, operation results data that results from execution of a given data operation. The operation results data can be stored, by the data processing platform and in a given portion of the data cache that corresponds to a given output variable. A given operation handler can be configured to store results data that results from execution of a given data operation, in a given portion of the data cache that corresponds to a given output variable. The data processing platform can receive a set of execution parameters in association with the multi-stage data operation. The set of execution parameters can include, for at least one data operation of the multi-stage data operation, a number of retries for the data operation. For at least one data operation in the series of data operations, a notification can be received from a given operation handler, that execution of the data operation has failed. In response to receiving the notification, the data processing platform can provide an instruction to re-execute the data operation. Coordinating execution of the series of data operations included in the multi-stage data operation can include maintaining a state object that tracks a current status of the data operations in the series of data operations, and providing the client device with access to the state object. A given operation handler can be selected from a pool of idle operation handlers that are configured to execute a given data operation. A number of idle operation handlers can be tracked over time. A number of active operation handlers can be increased in response to the number of idle operation handlers being fewer than a minimum threshold number. The number of active operation handlers can be decreased in response to the number of idle operation handlers being greater than a maximum threshold number.

The systems, devices, program products, and processes described throughout this document can, in some instances, provide one or more of the following advantages. A timely processing of recently collected data across disparate systems can be facilitated. A user-facing syntax can provide a simplified data operation definition grammar that enables platform users to define data operations without having to learn the particular domain-specific languages (DSLs) employed by various data sources. Multiple instances of a same type of operation handler can concurrently exist in a pool of operation handlers, and can concurrently perform assigned operations for completing different multi-stage data operations, while a data operation platform coordinates the data operations and facilitates the chaining of data results. By maintaining operation results data in a data cache for each successfully executed sub-operation until an overall multi-stage data operation has completed, the data operation platform can provide a recovery capability if any of the sub-operations were to fail (e.g., due to disasters, outages, and/or errors), thereby improving reliability. Further, the data cache can be data source agnostic, enabling seamless integration regardless of the data sources involved in the operations. Further, the data cache can facilitate fine-grained access and data manipulation on targeted data elements. The data operation platform can dynamically perform system balancing to ensure that an appropriate number of idle operation handlers are available for prompt execution of a data operation, while conserving system resources.

Other features, aspects and potential advantages will be apparent from the accompanying description and figures.

### DESCRIPTION OF DRAWINGS

FIG. 1 depicts an example system for performing multi-stage data operations.

FIGS. 2A-2F depict an example illustrative system and process for performing multi-stage data operations.

FIG. 3 depicts an example illustrative data flow for chaining data operations.

FIG. 4 is a flow diagram of an example technique for performing multi-stage data operations.

FIG. 5 is a schematic diagram that shows an example of a computing system.

Like reference symbols in the various drawings indicate like elements.

### DETAILED DESCRIPTION

This document describes technology that can perform multi-stage data operations that involve chaining data results from multiple different data sources, across a computer network. In general, multi-stage data operations can include data operations that are chained in such a way that the output of one operation may be filtered, modified, or otherwise transformed to serve as an input to a subsequent operation or render as a final output. A multi-stage data operation that has been defined in a user-facing syntax can be translated into an intermediate syntax. To perform the multi-stage data operation, an object expressed in the intermediate syntax can be parsed by a data operation platform, which traverses the nodes of the object sequentially and identifies the various operations represented in the object. For each identified operation, the data operation platform determines the type of operation, translates the portion of the object that corresponds to the operation into domain-specific syntax, and provides the domain-specific syntax to an operation handler that is configured to perform the operation on a specified data source. After each identified operation has been successfully performed, an overall result of the multi-stage data operation can be provided.

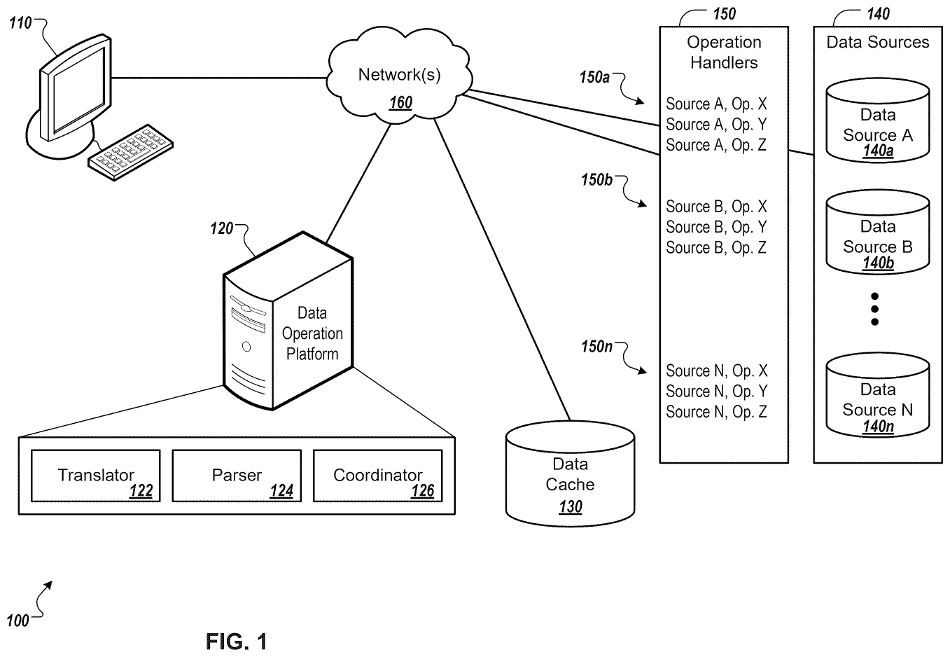

FIG. 1 depicts an example system 100 for performing multi-stage data operations. In general, the system 100 can include various computing devices, computing server systems, and data stores, configured to communicate over one or more networks. For example, the system 100 can include a client computing device 110, a data operation platform 120, a data cache 130, multiple different data sources 140, and a pool of operation handlers 150, that can communicate and exchange data over network(s) 160 (e.g., including one or more LANs (local area networks), WANs (wide area networks), and/or the Internet).

The client computing device 110, for example, can represent various forms of stationary or mobile computing devices including, but not limited to a desktop computer, a laptop computer, a tablet computer, a personal digital assistant (PDA), a smartphone, or other processing devices. In general, the client computing device 110 can be used to generate definition data for multi-stage data operations to be performed by the data operation platform 120. Further, the client computing device 110 can potentially be used to monitor the status of the multi-stage operations in real-time as the operations are being performed, and to present information related to the results of performed operations (e.g., a final result of a multi-stage query). The client computing device 100, for example, can include various input devices (e.g., keyboard, mouse, pointer, touchscreen, microphone, etc.) for receiving input from a device operator, and various output devices (e.g., display, printer, speaker, etc.) for presenting output to the device operator.

The data operation platform 120, for example, can represent various forms of servers, including but not limited to network servers, web servers, application servers, or other suitable computing servers. In general, the data operation platform 120 can receive definition data for multi-stage data operations from the client computing device 110 (or another computing device/server), and can execute instructions for performing the data operations (e.g., a series of queries and/or other data functions). To perform the data operations, for example, the data operation platform 120 can include various software components (e.g., applications, modules, objects, or other suitable software components), which may be combined or separate, and may be co-located (e.g., executed by a same server) or distributed (e.g., executed by different servers). In the present example, the data operation platform 120 can include a translator 122, a parser 124, and a coordinator 126. The translator 122, for example, can translate a defined data operation that is expressed in a first format, to a defined data operation that is expressed in a second, different format. The parser 124, for example, can parse a defined data operation to identify various elements of the operation (e.g., functions, commands, variables, data source identifiers, etc.), and can provide the identified elements to downstream components (e.g., the translator 122 and/or the coordinator 126). The coordinator 126, for example, can coordinate the various different operations of a multi-stage data operation, including selecting an appropriate operation handler for performing a particular data operation (e.g., from the pool of operation handlers 150), and optionally caching the results of the data operation (e.g., in the data cache 130) and providing the cached results to an operation handler of a downstream operation.

The data cache 130, for example, can represent one or more databases, file systems, and/or memory-based cached data sources. In general, the data cache 130 can cache the results of one or more data operations included in a multi-stage data operation, and can provide the cached results as input to one or more downstream data operations included in the multi-stage data operation. For example, the data cache 130 can serve as a centralized data repository that maintains data operation results generated by upstream selected operation handlers 150, and can serve as a source of parameterized input to downstream selected operation handlers 150. The data cache 130, for example, can store data in a defined format (e.g., a JavaScript Object Notation (JSON) format, or another suitable format for storing and exchanging data), and can facilitate fine-grained data access and manipulation. The data resulting from each stage of a multi-stage data operation (e.g., intermediate results) can be maintained in the data cache 130, allowing for retries and recovery in the event of disasters, outages, errors, etc. For example, the intermediate results can be cached for recovery purposes until the multi-stage data operation is completed, thereby ensuring reliability.

In some implementations, access to a data cache for performing a multi-stream data operation may be facilitated by a data operation platform. For example, the data operation platform 120 can access the data cache 130 (e.g., maintained in memory of the platform, a database and/or file system of the platform, etc.), and can serve as an intermediary between the data cache 130 and various operation handlers 150, by receiving results data from one or more of the handlers 150, caching the results data, and providing the cached results data to other handlers 150.

In some implementations, access to a data cache for performing a multi-stream data operation may be provided directly to at least some operation handlers that are involved in a multi-stage data operation. For example, at least some of the operation handlers 150 can be configured to directly access the data cache 130 (e.g., maintained as a memory-based cache, database, and/or file system that is external to the data operation platform 120), thereby directly caching data for downstream operations and/or retrieving cached data that resulted from upstream operations.

The data sources 140 (e.g., data source 140a, data source 140b, data source 140n, etc.), for example, can represent one or more databases, file systems, and/or memory-based data sources. In general, data maintained by the data sources 140a-n can include data that is continually collected and that is appended to the data sources 140a-n in real-time, as the data is being collected. Further, each of the data sources 140a-n can include data from a different data collection system and/or a different type of data. For example, a first event data log can include network traffic data for various computing nodes across an enterprise's computer network, a second event data log can include transaction data that represents purchases conducted across various accounts, a third event data log can include sensor data (e.g., badge scan data, data based on image sensors, etc.) that represents actions that occurred in a physical environment, and so forth. Each of the data sources 140a-n, for example, can include a vast amount of data (e.g., terabytes, petabytes), which may or may not be perpetually maintained. For example, some data sources can be periodically purged or archived, with only a most recent portion of the data (e.g., data collected within the current hour, day, week, or another suitable time period) being maintained or readily accessible. Further, each of the data sources 140a-n may be maintained by a different data repository system, and thus may be accessible using different data access techniques employed by various different operation handlers 150. Thus, the technology described herein can facilitate a timely processing of recently collected data across disparate systems.

The operation handlers 150, for example, can represent computer software components (e.g., applications, modules, objects, or other suitable software components) that are configured to access the data sources 140 and to perform various data operations based on the accessed data. In general, different data sources can be accessed using a different control syntax and/or a different data access technique. Thus, in some implementations, a particular operation handler may be configured to interface with a particular data source. In the present example, a first set of operation handlers 150a are configured to interface with data source 140a (“Data Source A”), a second set of operation handlers 150b are configured to interface with data source 140b (“Data Source B”), and a third set of operation handlers 150n are configured to interface with data source 140n (“Data Source N”). Further, in some implementations, a particular operation handler may be configured to perform a particular data operation (e.g., across multiple different data sources, or for a single data source). In the present example, each operation handler in the first set of operation handlers 150a (e.g., “Op. X, Op. Y, and Op. Z”) is configured to perform respective data operations on data source 140a, each operation handler in the second set of operation handlers 150b (e.g., “Op. X, Op. Y, and Op. Z”) is configured to perform respective data operations on data source 140b, and each operation handler in the third set of operation handlers 150n (e.g., “Op. X, Op. Y, and Op. Z”) is configured to perform respective data operations on data source 140n.

In some implementations, at least some operation handlers may be executed by a data operation platform. For example, the data operation platform 120 can activate a local pool of operation handlers (e.g., at least some of the operation handlers 150), can select particular local handlers for performing particular operations, can execute and coordinate the operations (e.g., by caching local results data from the operations, and by providing cached results data to other operations), and can optionally deactivate idle operation handlers. In the present example, local control of the operation handlers can be maintained, which can increase overall processing speed at the possible expense of increased data transmission.

In some implementations, at least some operation handlers may be executed by a computing device that is remote from a data operation platform and that is local to a data source. For example, the data operation platform 120 can transmit instructions to a remote computing device (e.g., a computing device that is local to one or more of the data sources 140) to activate a remote pool of operation handlers (e.g., at least some of the operation handlers 150), can select particular remote handlers for performing particular operations, can coordinate the operations (e.g., by caching remote results data from the operations, and by providing cached results data to other operations), and can optionally transmit instructions to the remote computing device to deactivate idle operation handlers. In the present example, remote control of the operation handlers can decrease an amount of data transmission at the possible expense of decreased overall processing speed.

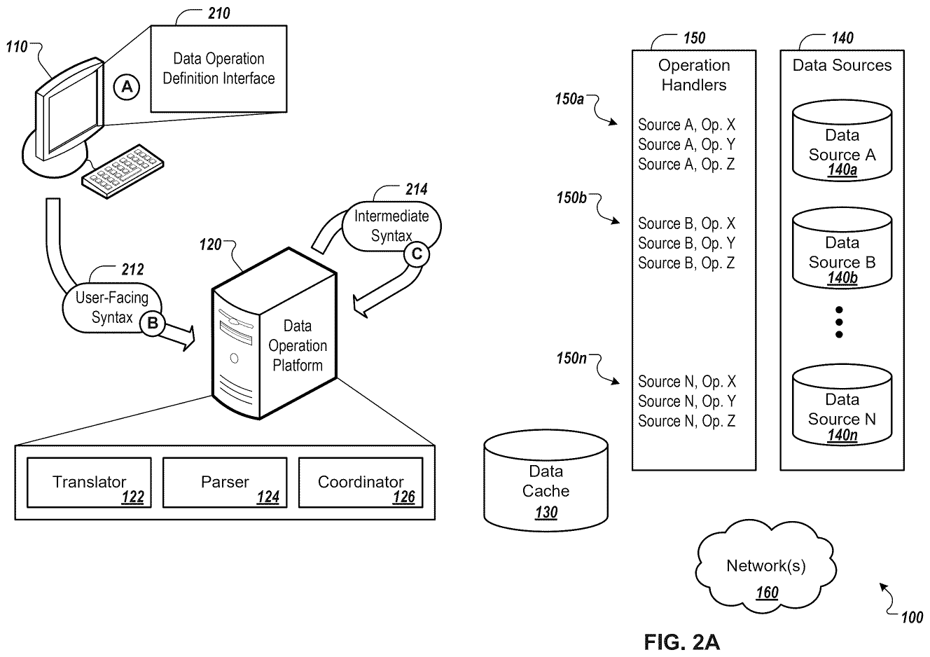

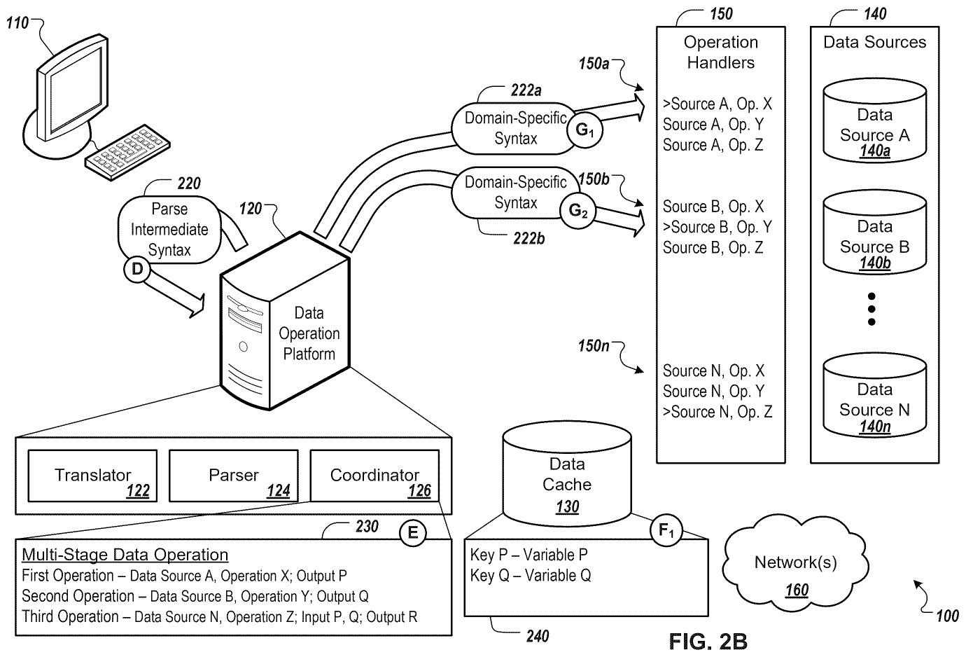

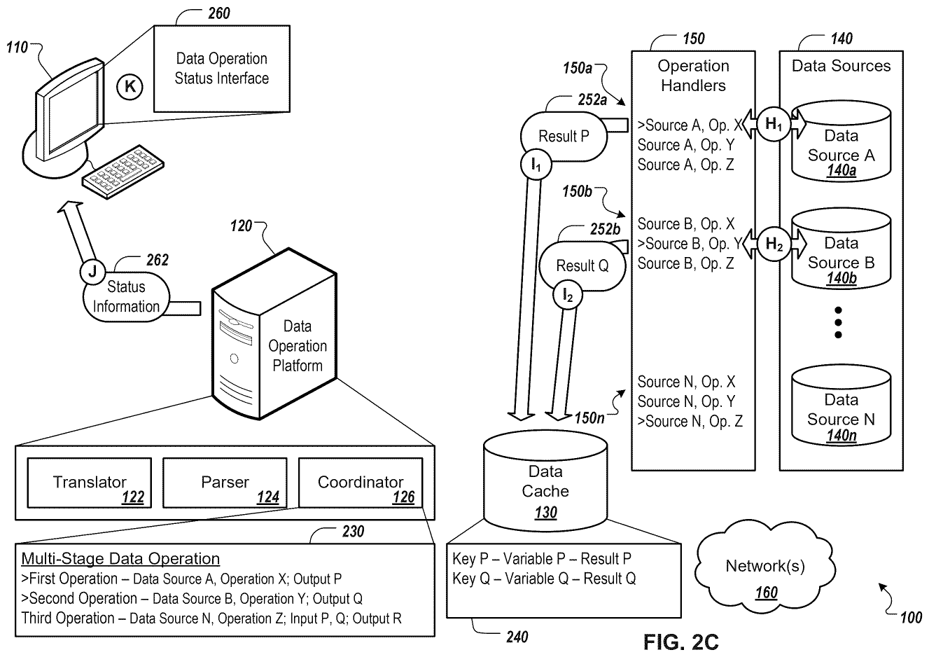

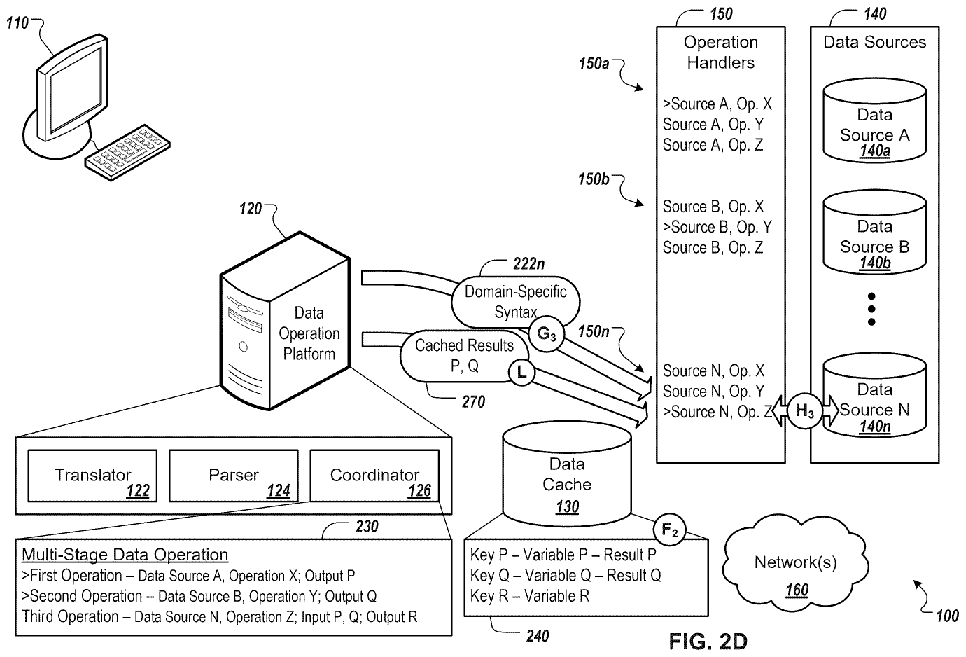

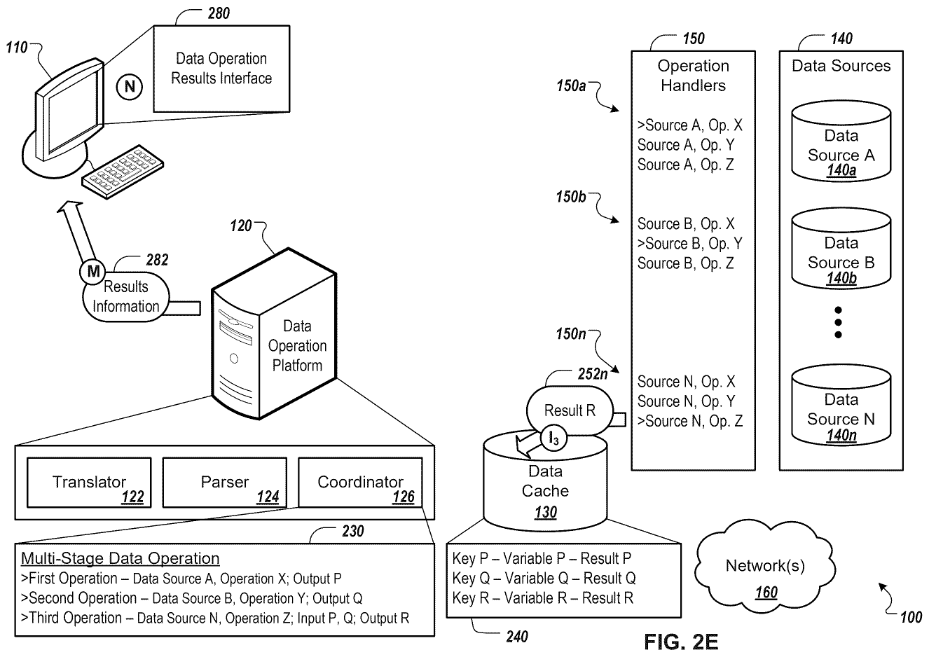

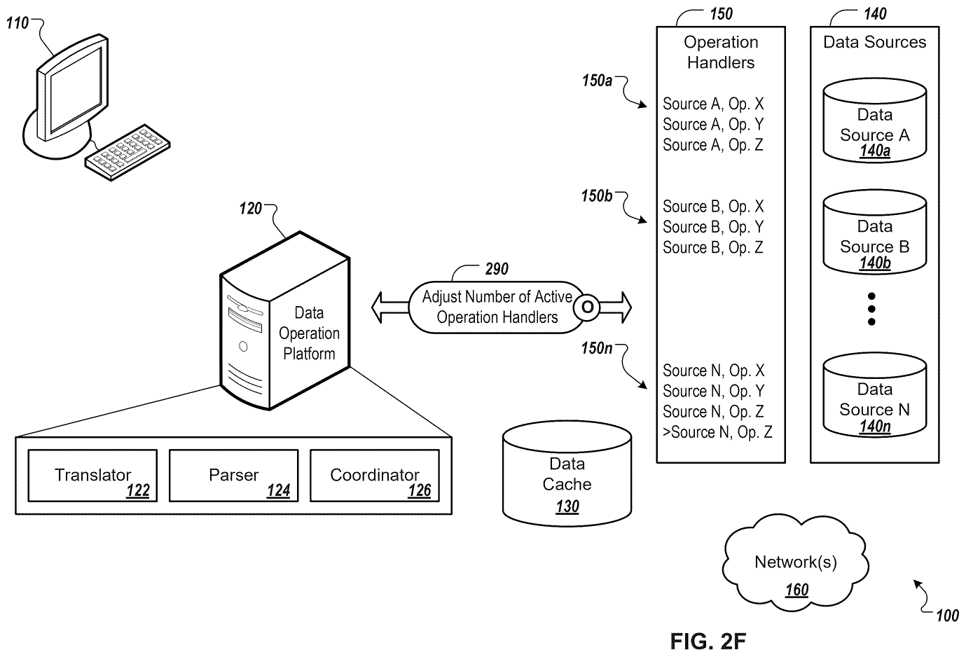

Referring now to FIGS. 2A-2F, an example illustrative system (e.g., system 100, also shown in FIG. 1) and process are shown for performing multi-stage data operations, as represented in example stages (A) to (O). Stages (A) to (O) may occur in the illustrated sequence, or they may occur in a sequence that is different than in the illustrated sequence, and/or two or more stages (A) to (O) may be concurrent. In some examples, one or more stages (A) to (O) may be repeated multiple times when performing multi-stage data operations, when reporting such operations, and/or when managing a pool of operation handlers.

Referring to FIG. 2A, during stage (A), the client computing device 110 can present a data operation definition interface 210. An operator of the client computing device 110, for example, can use the data operation definition interface 210 to define a multi-stage data operation to be performed by the data operation platform 120, including various instructions (e.g., queries, parameters, commands, and/or executable computer code) for performing the multi-stage data operation. In some implementations, a data operation definition interface can include an editor to facilitate the generation of instructions for performing a multi-stage data operation, expressed in a user-facing syntax. For example, the data operation definition interface 210 can include a user-facing syntax editor that can reference particular data sources 140 and user-defined data variables, commands for querying data included in the data sources, commands for performing operations on data that results from the queries (e.g., aggregation, frequency, matching, etc.), and other sorts of operations.

In some implementations, a data operation definition interface can include various controls that can receive input for defining multi-stage data operation. For example, the data operation definition interface 210 can include a set of controls for defining the multi-stage data operation, which can be interacted with by an operator of the interface, thereby facilitating an automatic generation of user-facing syntax for the multi-stage data operation. As another example, a data operation definition interface can include a hybrid of data operation definition controls and user-facing syntax editing controls. Upon submitting a definition of a multi-stage data operation through the data operation definition interface 210, for example, the client computing device 110 and/or the data operation platform 120 can validate the user-facing syntax and can generate user feedback regarding any errors that may exist for correction.

During stage (B), the data operation platform 120 can receive a definition of a multi-stage data operation that has been expressed in user-facing syntax 212. In general, the user-facing syntax 212 can provide a simplified data operation definition grammar that enables platform users to define data operations without having to learn the particular domain-specific languages (DSLs) employed by each of the data sources 140. Further, the user-facing syntax 212 can be extendable to support new operations that may be supported by one or more of the data sources 140 over time.

In general, a multi-stage data operation can include a series of data operations that are chained in such a way that the output of one operation is filtered, modified, or otherwise transformed to serve as an input to a subsequent operation or is rendered as a final output. In some examples, general guidelines for the user-facing syntax can include beginning a multi-stage data operation with an INDEX operation (e.g., an operation that specifies a data source and a query), and using a FILTER operation (e.g., an operation that processes the output of a prior stage through a defined filter) or a function query (e.g., SQL) to incorporate results from a previous query into a next result. The various operations of a multi-stage data operation, for example, can be chained together using the user-facing syntax, through an operation separation character (e.g., a pipe character “|” or another suitable separation character). Types of operations (and aspects of the operations) that may be expressed through the user-facing syntax can include a TERMS aggregation (e.g., storing previous results in a variable name provided after an AS term), a reference to an @results variable (e.g., using the variable to access the results of a previous operation), a FILTER query with field selection (e.g., iterating over a hits array and generating an object for each hit containing defined properties), a GROUPBY aggregation (e.g., grouping returned results by a specified field), a SQL JOIN (e.g., returning the values in a first set and second set joined on a given field), a WHERE_NOT_IN function (e.g., returning the set of values in a first set that are not in a second set for a given field), a SQL TIME_FILTER (e.g., filtering results down to events that occurred within a specified duration of time), a JARO WINKLER function (e.g., returning results that have a specified similarity score), a REDUCE DISTINCT function (e.g., filtering objects by a list of distinct values), and other suitable data operations.

During stage (C), the user-facing syntax 212 of the multi-stage data operation can be translated into an intermediate syntax 214. For example, after receiving the user-facing syntax 212, the data operation platform 120 can use the translator 122 to translate the user-facing syntax 212 into the intermediate syntax 214. As another example, the client computing device 110 can be configured to receive the user-facing syntax 212 through the data operation definition interface 210, to translate the user-facing syntax 212 into the intermediate syntax 214, and to provide the intermediate syntax 214 to the data operation platform 120.

In general, the intermediate syntax 214 can be a relatively low-level and system-neutral syntax that is configured such that the syntax is traversable by computing devices, and can be parsed and translated by the computing devices into various domain-specific languages (DSLs) that may be used by various different data sources 140. In some examples, the intermediate syntax 214 can be an abstract syntax tree (AST) that models the relationship between the various operations, through a node-based structure.

Referring now to FIG. 2B, during stage (D), the data operation platform 120 can parse 220 the intermediate syntax (e.g., using the parser 124), to identify a series of data operations included in a defined multi-stage data operation 230. In some implementations, parsing a definition of a multi-stage data operation may include traversing nodes of an abstract syntax tree (AST). For example, each data operation in the multi-stage data operation 230 can be defined in a respective node of the abstract syntax tree of the intermediate syntax 214 (shown in FIG. 2A). In the present example, the multi-stage data operation 230 includes a first operation that references data from data source 140a (“Data Source A”), a second operation that references data from data source 140b (“Data Source B”), and a third operation that references data from data source 140n (“Data Source N”). The first operation of the present example is an “X” type of operation that associates operation results with a “P” output variable. The second operation of the present example is a “Y” type of operation that associates operation results with a “Q” output variable. The third operation of the present example is a “Z” type of operation that accepts as input both the “P” output from the first operation and the “Q” output from the second operation, and that associates operation results with an “R” output variable.

During stage (E), the data operation platform 120 can use the coordinator 126 to coordinate execution of the series of data operations included in the defined multi-stage data operation 230. In general, coordination of the series of data operations included in a multi-stage data operation can include, for each data operation in the series of data operations, selecting a respective operation handler that is configured to execute the data operation, generating a domain-specific syntax that is used by the selected operation handler for executing the data operations, and providing the domain-specific syntax to the selected operation handler for executing the data operation.

In the present example, during stage (F₁), for each of the first operation and the second operation, the data operation platform 120 can identify respective output variables that indicate output of the respective operations, and can map a portion of the data cache 130 to the respective output variables. For example, the data operation platform 120 can generate and maintain a cache key “Key P” that references a portion of the data cache 130 that is to eventually store a data value for “Variable P” to be output by the first operation, and can generate and maintain a cache key “Key Q” that references a portion of the data cache 130 that is to eventually store a data value for “Variable Q” to be output by the second operation. The data operation platform 120, for example, can maintain (e.g., in memory) an association between each cache key and each respective output variable.

Continuing the present example, during stage (G₁), the data operation coordinator 126 can select from the pool of operation handlers 150, an operation handler that is configured to execute the first operation (e.g., “Source A, Op. X” in the first set of operation handlers 150a), can use the translator 122 to generate domain-specific syntax 222a that is used by the selected operation handler for executing the data operation, and can provide the generated domain-specific syntax 222a to the selected operation handler. During stage (G₂), the coordinator 126 can select from the pool of operation handlers 150, an operation handler that is configured to execute the second operation (e.g., “Source B, Op. Y” in the second set of operation handlers 150b), can use the translator 122 to generate domain-specific syntax 222b that is used by the selected operation handler for executing the data operation, and can provide the generated domain-specific syntax 222b to the selected operation handler. Each of the selected operation handlers in the present example can currently be idle operation handlers that are waiting for an assigned operation by the data operation platform 120, and can be executed by a computing device that is local to their respective data sources 140a, 140b.

In general, each data operation in a series of data operations may be executed sequentially. For example, the coordinator 126 of the data operation platform 120 can coordinate execution of the first operation, wait for execution of the first operation to complete, then coordinate execution of the second operation, and so forth until all stages of the multi-stage data operation 230 are complete. In alternate examples, the coordinator 126 of the data operation platform 120 can coordinate a concurrent execution of two or more data operations that do not depend on input from other data operations (e.g., the first operation and the second operation). For operations that are to receive as input the results data from other data operations (e.g., the third operation), the coordinator 126 can wait until such time that the results data is available before coordinating execution of the operations.

Referring now to FIG. 2C, during stages (H₁) and (H₂), the respective operation handlers “Source A, Op. X” and “Source B, Op. Y” can execute data operations (e.g., sequentially or concurrently) on the respective data sources 140a (“Data Source A”) and 140b (“Data Source B”). Executing the data operations, for example, can include executing the respective domain-specific syntax 222a, 222b (shown in FIG. 2B) on the respective data sources 140a, 140b. In the present example, after executing “Operation X” on “Source A,” operation handler “Source A, Op. X” can return a data result 252a (e.g., “Result P”) during stage (I₁). Continuing the present example, after executing “Operation Y” on “Source B,” operation handler “Source B, Op. Y” can return a data result 252b (e.g., “Result Q”) during stage (I₂).

In some implementations, a data operation platform may receive operation results data that results from execution of a data operation, and may store the operation results data in a portion of a data cache that corresponds to an output variable. For example, the data operation platform 120 can receive the data result 252a (“Result P”) from the operation handler “Source A, Op. X,” can locate a portion of the data cache 130 that maps to “Variable P” (e.g., using “Key P”), and can store “Result P” in the located portion of the data cache 130. Similarly, the data operation platform 120 can receive the data result 252b (“Result Q”) from the operation handler “Source B, Op. Y,” can locate a portion of the data cache 130 that maps to “Variable Q” (e.g., using “Key Q”), and can store “Result Q” in the located portion of the data cache 130.

In some implementations, an operation handler may be configured to store results data that results from execution of a data operation, in a portion of a data cache that corresponds to an output variable. For example, the operation handler “Source A, Op. X,” can locate a portion of the data cache 130 that maps to “Variable P” (e.g., using “Key P”), and can store “Result P” in the located portion of the data cache 130. Similarly, the operation handler “Source B, Op. Y,” can locate a portion of the data cache 130 that maps to “Variable Q” (e.g., using “Key Q”), and can store “Result Q” in the located portion of the data cache 130.

In some implementations, an operation handler may be configured to perform data operations according to a set of execution parameters. For example, the operation handler “Source A, Op. X” can be associated with execution parameters that specify, for a data operation, a number of retries for the data operation, a timeout value for the data operation, etc. The execution parameters, for example, can be adjusted through a configuration process (e.g., by an operator of the data operation platform 120).

In some implementations, a notification may be received from an operation handler that execution of a data operation has failed and/or timed out, and in response to receiving the notification, an instruction to re-execute the data operation can be provided. For example, the coordinator 126 of the data operation platform 120 can receive from an operation handler in the pool of operation handlers 150 a notification that a data operation has failed (and/or has timed out, according to a timeout parameter that has been specified in execution parameters for the data operation), and in response, the coordinator 126 can provide an instruction to the operation handler to retry execution of the data operation. A retry process can be repeated, for example, until such time that a specified number or retries has been exhausted (e.g., according to a number of retries that has been specified in execution parameters for the data operation).

During stage (J), the data operation platform 120 can provide status information 262 to the client computing device 110. For example, the coordinator 126 of the data operation platform 120 can maintain (e.g., in memory) a state object that tracks a current status of data operations of the multi-stage data operation 230, and can provide the client computing device 110 with access to the state object. For example, the state object can indicate a status of each operation of the multi-stage data operation 230 (e.g., whether the operation is in progress, has completed, or has failed) as the operations are being queued and executed, and when the operations have finished. When an operation is initiated, for example, its status can initially be set to “in progress,” and its status can remain “in progress” until such time that the operation has failed (e.g., with the specified number of retries being exhausted and/or the specified timeout period having elapsed) or has successfully been completed. When the operation has failed or has successfully been completed, for example, its status can be updated appropriately.

During stage (K), current status information can be presented by the computing device 110 through a data operation status interface 260. In the present example, the current status information can indicate that the first operation and the second operation have successfully completed, and the third operation has not yet been initiated (or is currently in progress).

Referring now to FIG. 2D, during stage (F₂), for the third operation, the data operation platform 120 can identify an output variable that indicates output of the operation (e.g., “Variable R”), and can map a portion of the data cache 130 to the output variable. For example, the data operation platform 120 can generate and maintain a cache key “Key R” that references a portion of the data cache 130 that is to eventually store a data value for “Variable R” to be output by the third operation (e.g., a final result of the multi-stage data operation 230). Further, in the present example, the data operation platform 120 can identify input variables for the third operation (e.g., “Variable P” and “Variable Q”) that correspond to output variables of the respective first and second operations. Using the keys “Key P” and “Key Q,” for example, the data operation platform 120 can retrieve respective result data “Result P” and “Result Q” from respective portions of the data cache 130 that are mapped to the identified input variables “Variable P” and “Variable Q”, and can provide the retrieved data to a selected operation handler for executing the third operation.

Continuing the present example, during stage (G₃), the coordinator 126 can select from the pool of operation handlers 150, an operation handler that is configured to execute the third operation (e.g., “Source N, Op. Z” in the third set of operation handlers 150n), can use the translator 122 to generate domain-specific syntax 222n that is used by the selected operation handler for executing the data operation, and can transmit the generated domain-specific syntax 222n to the selected operation handler. Further, in the present example, during stage (L), the data operation platform can transmit cached data results 270 (e.g., “Result P” and “Result Q”), either along with the domain-specific syntax 222n or separately, to the selected operation handler. As another example, the selected operation handler “Source N, Op. Z” can retrieve the cached data results 270 directly from the data cache 130.

Continuing the present example, during stage (H₃), the operation handler “Source N, Op. Z” can execute the data operation on the data source 140n (“Data Source N”). Executing the data operation, for example, can include executing the domain-specific syntax 222n on the data source 140n and using the cached data results 270 to determine a final result of the multi-stage data operation 230.

Referring now to FIG. 2E, after executing “Operation Z” on “Source N”, during stage (I₃), operation handler “Source N, Op. Z” can return a data result 252n (e.g., “Result R”), which can represent the final result of the multi-stage data operation 230, and can optionally be stored in a portion of the data cache 130 that corresponds to output variable “Variable R.” In the present example, the state object maintained by the coordinator 126 can be updated to indicate that the third operation has successfully completed, and the current status information can be presented by the computing device 110 through the data operation status interface 260 (shown in FIG. 2C).

Continuing the present example, during stage (M), the data operation platform 120 can provide results information 282 to the client computing device 110. The results information, for example, can include the final result of the multi-stage data operation 230 (e.g., the result 252n, “Result R”). During stage (N), the results information can be presented by the computing device 110 through a data operation results interface 280.

In general, after a multi-stage data operation has been completed, cached data from various sub-operations included in the multi-stage data operation can be cleared by the data operation platform 120 at an appropriate time (e.g., immediately afterwards or after a specified amount of time has elapsed, such as ten minutes, an hour, or another appropriate amount of time). By maintaining operation results data in the data cache 130 for each successfully executed sub-operation until the overall multi-stage data operation 230 has completed, for example, the data operation platform 120 can provide a recovery capability if any of the sub-operations were to fail. For example, rather than restarting from the beginning of the multi-stage data operation 230 in the event of failure of any of its sub-operations, a failed sub-operation can be re-executed and can again be provided with its input from the data cache 130. Thus, system robustness can be improved via interactions between the data operation platform 120, the data cache 130, and the pool of operation handlers 150.

Although the present example shows a request for a single multi-stage data operation 230 being transmitted by a single client computing device 110 and being processed by the data operation platform 120, it will be appreciated that multiple different client computing devices (and other sorts of computing devices) can concurrently transmit requests for processing multi-stage data operations, and the data operation platform 120 can concurrently handle such requests. For example, upon receiving a new request for processing a multi-stage data operation, the data operation platform 120 can translate/parse the request (e.g., using the translator 122 and the parser 124) to identify a series of data operations in the multi-stage data operation, and can select currently idle operation handlers to execute the data operations from the pool of operation handlers 150. After an operation handler has completed its assigned data operation, it can then return to an idle state and wait for another data operation to be assigned to it. Thus, multiple instances of a same type of operation handler (e.g., a type of operation handler that is configured to perform data operations on a given data source and/or for a given type of operation) can concurrently exist in the pool of operation handlers 150, and can concurrently perform assigned operations for completing different multi-stage data operations, while the data operation platform 120 coordinates the data operations and facilitates the chaining of data results.

Referring now to FIG. 2E, during stage (O), a number of active operation handlers can be adjusted. For example, the data operation platform 120 can track a number of active and idle operation handlers in the pool of operation handlers 150 over time, as data operations are being executed. Active operation handlers, for example, can include operation handlers that have been spooled up and are either currently performing a data operation or are waiting for an assigned data operation, whereas idle operation handlers can include operation handlers that are currently waiting for an assigned data operation. When a number of idle operation handlers is fewer than a minimum threshold number, for example, a number of active operation handlers can be increased. When a number of idle operation handlers is greater than a maximum threshold number, for example, a number of active operation handlers can be decreased. The data operation platform 120, can adjust a number of active operation handlers for particular data sources and/or particular types of data operations, for example. Thus, the data operation platform 120 can dynamically perform system balancing to ensure that an appropriate number of idle operation handlers are available for prompt execution of a data operation—not too few such as to create a process bottleneck, but not too many as to waste system resources.

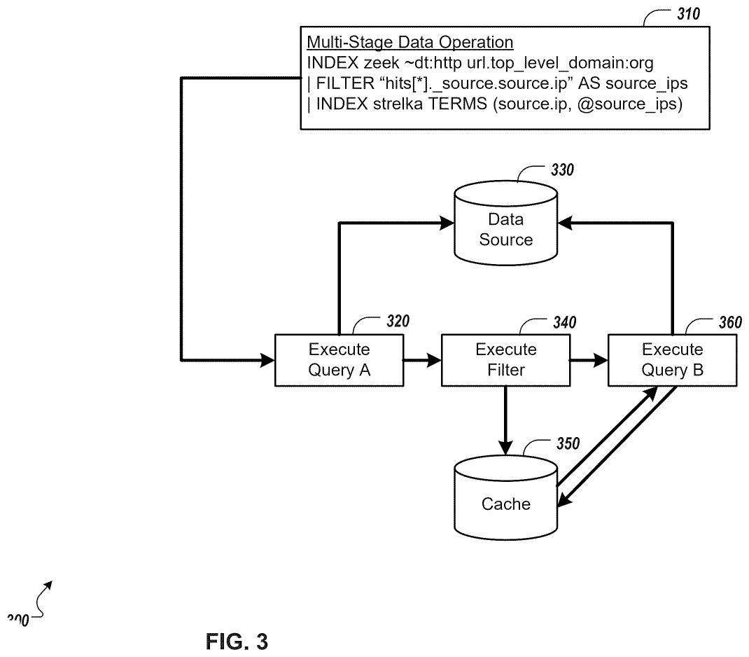

FIG. 3 depicts an example illustrative data flow 300 for chaining data operations. The illustrative data flow 300, for example, shows a specific example of a multi-stage data operation 310 that is expressed in an example user-facing syntax. In the present example, the multi-stage data operation 310 includes a series of data operations separated by pipe characters, including an initial query (e.g., INDEX zeek ~dt:http url.top_level_domain:org), a filter operation that is to be applied on results data from the initial query (e.g., FILTER “hits[*]._source.source.ip” AS source_ips), and a subquery that uses a list variable that has been developed through the prior operations (e.g., INDEX strelka TERMS (source.ip, @source_ips)). While the user-facing syntax of the multi-stage data operation 310 is being shown and described in the present example, it is to be understood that execution of the data operations may involve a translation of the user-facing syntax into a domain-specific syntax.

At 320, the operation “Query A” (e.g., the initial query of “INDEX zeek ~dt:http url.top_level_domain:org”) is executed. In the present example, Query A is used to collect a set of documents, where the index being queried is a Zeek network security monitoring data source (e.g., INDEX zeek), the datatype is “http” (e.g., ~dt:http), and the URL (Universal Resource Locator) top-level domain is “org” (e.g., url.top_level_domain:org). The operation Query A, for example, can be executed on the data source 330 (e.g., similar to the data sources 140, shown in FIG. 1) by a selected one of the operation handlers 150 (also shown in FIG. 1).

At 340, the filter operation (e.g., FILTER “hits[*]._source.source.ip” AS source_ips) is executed. In the present example, the filter operation is used to process the output of the prior stage (e.g., the set of documents collected by Query A), by iterating through the array of documents (e.g., hits[*]), and by taking from each document (e.g., ._source) the contents of its “source.ip” field (e.g., .source.ip). The source.ip's can be mapped to a variable (e.g., a list variable) named “source_ips” (e.g., AS source_ips), which can be maintained in a cache 350 (e.g., similar to the data cache 130, shown in FIG. 1).

At 360, the operation “Query B” (e.g., the subquery “INDEX strelka TERMS (source. ip, @source_ips)” that uses the list variable that has been developed through Query A and the executed filter operation, is executed. In the present example, the query operation is executed against a Strelka real-time threat detection data source (e.g., INDEX strelka), where the source.ip (e.g., TERMS (source.ip,)) is in the previously defined list of source_ips according to the mapped variable (e.g., @source_ips). For example, the previously defined list of source_ips can be retrieved by accessing data associated with the mapped variable “@source_ips” in the cache 350, and the operation Query B can be executed on the data source 330 by a selected one of the operation handlers 150. In the present example, Query B can return a series of Strelka events with source IP's identified as being related to a .org top level domain from Zeek data.

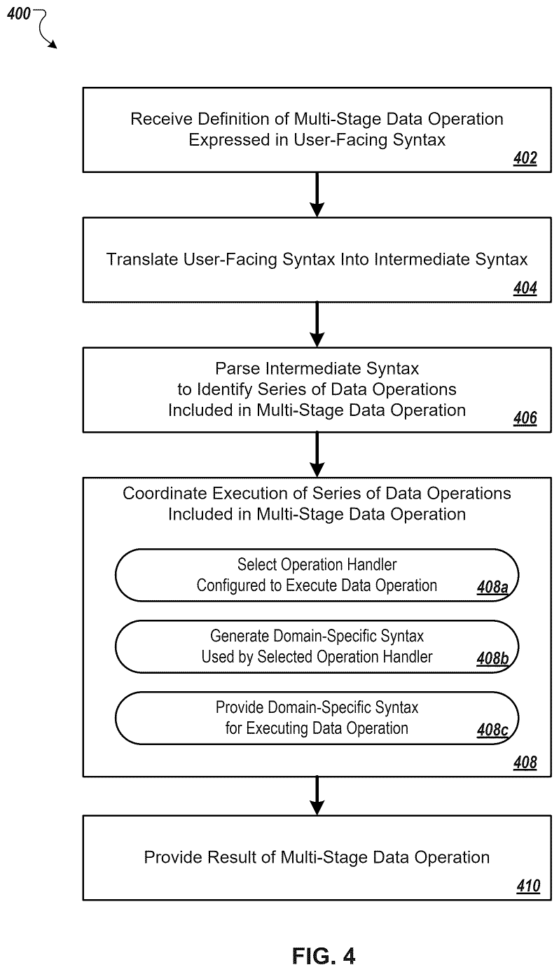

FIG. 4 is a flow diagram of an example technique 400 for performing multi-stage data operations. The technique 400, for example, can be performed by components of the system 100 (shown in FIG. 1), and will be described as such with reference to the example stages (A) to (O) (shown in FIGS. 2A-2F) for clarity. However, the technique 400 can also be performed by other systems and platforms.

At 402, a definition is received of a multi-stage data operation expressed in a user-facing syntax. Referring to FIG. 2A, for example, during stage (B), the data operation platform 120 can receive the user-facing syntax 212. The user-facing syntax 212, for example, can be generated by the client computing device 110 (e.g., through the data operation definition interface 210 during stage (A)), and can be provided by the client computing device 110 to the data operation platform 120.

At 404, the user-facing syntax is translated into an intermediate syntax. Referring again to FIG. 2A, for example, during stage (C), the data operation platform 120 can use the translator 122 to translate the user-facing syntax 212 of the multi-stage data operation into a definition of the multi-stage data operation that is expressed in the intermediate syntax 214. In the present example, the intermediate syntax 214 can be represented in an abstract syntax tree (AST), or another suitable format that can be readily parsed and traversed by a computing device.

At 406, the intermediate syntax is parsed to identify a series of data operations included in the multi-stage data operation. Referring now to FIG. 2B, during stage (D), the data operation platform 120 can use the translator 122 to parse the intermediate syntax (here shown as intermediate syntax 220) of the multi-stage data operation, to identify a series of data operations included in the muti-stage data operation (here shown as multi-stage data operation 230).

At 408, execution of a series of data operations included in the multi-stage data operation is coordinated. Referring to FIGS. 2B-2D, during stages (E) to (L), the data operation platform 120 can use the coordinator 126 to coordinate the first, second, and third data operations of the multi-stage data operation 230.

At 408a, an operation handler is selected that is configured to execute a data operation. For example, the coordinator 126 can select an operation handler for each of the first, second, and third data operations from the pool of operation handlers 150. Each selected operation handler, for example, can be configured to execute a respective operation.

At 408b, a domain-specific syntax is generated that is used by the selected operation handler. For example, the coordinator 126 can use the translator 122 to translate a portion of the intermediate syntax 220 that pertains to a respective data operation (e.g., each of the first, second, and third data operations), into respective domain-specific syntax 222a, 222b, 222n that is used by a selected operation handler for executing the respective data operation.

At 408c, the domain-specific syntax is provided for executing the data operation. For example, the coordinator 126 can provide the respective domain-specific syntax 222a, 222b, 222n to the respective selected operation handlers, for executing the respective first, second, and third data operations.

At 410, a result of the multi-stage data operation is provided. Referring now to FIG. 2E, during stage (M), the data operation platform 120 can provide the results information 282 that is based on a chaining of the first, second, and third operations, to the client computing device 110 for presentation at the data operation results interface 280 (during stage (N)).

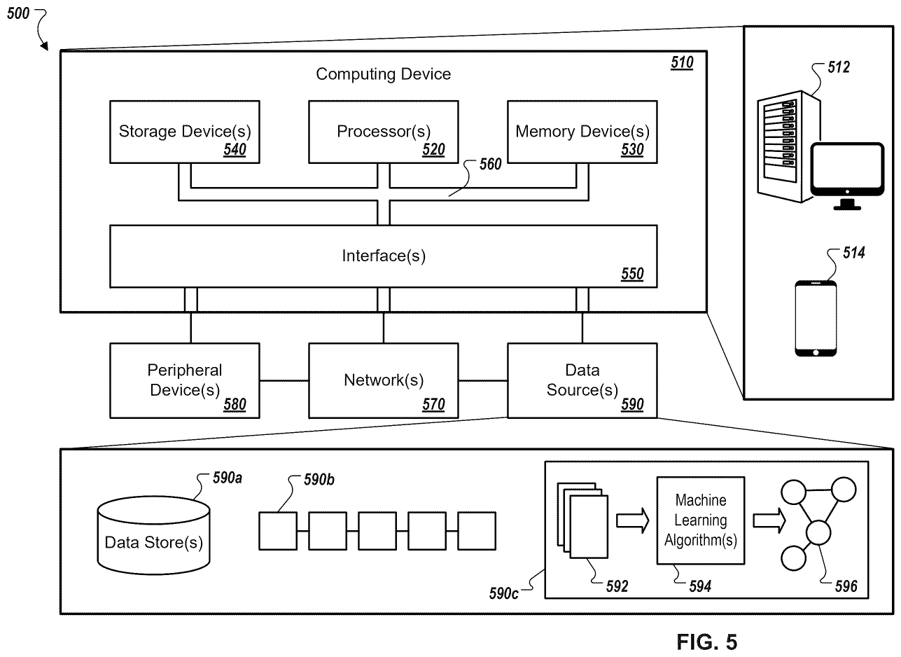

FIG. 5 is a schematic diagram that shows an example of a computing system 500 that can be used to implement the techniques described herein. The computing system 500 includes one or more computing devices (e.g., computing device 510), which can be in wired and/or wireless communication with various peripheral device(s) 580, data source(s) 590, and/or other computing devices (e.g., over network(s) 570). The computing device 510 can represent various forms of stationary computers 512 (e.g., workstations, kiosks, servers, mainframes, edge computing devices, quantum computers, etc.) and mobile computers 514 (e.g., laptops, tablets, mobile phones, personal digital assistants, wearable devices, etc.). In some implementations, the computing device 510 can be included in (and/or in communication with) various other sorts of devices, such as data collection devices (e.g., devices that are configured to collect data from a physical environment, such as microphones, cameras, scanners, sensors, etc.), robotic devices (e.g., devices that are configured to physically interact with objects in a physical environment, such as manufacturing devices, maintenance devices, object handling devices, etc.), vehicles (e.g., devices that are configured to move throughout a physical environment, such as automated guided vehicles, manually operated vehicles, etc.), or other such devices. Each of the devices (e.g., stationary computers, mobile computers, and/or other devices) can include components of the computing device 510, and an entire system can be made up of multiple devices communicating with each other. For example, the computing device 510 can be part of a computing system that includes a network of computing devices, such as a cloud-based computing system, a computing system in an internal network, or a computing system in another sort of shared network. Processors of the computing device (510) and other computing devices of a computing system can be optimized for different types of operations, secure computing tasks, etc. The components shown herein, and their functions, are meant to be examples, and are not meant to limit implementations of the technology described and/or claimed in this document.

The computing device 510 includes processor(s) 520, memory device(s) 530, storage device(s) 540, and interface(s) 550. Each of the processor(s) 520, the memory device(s) 530, the storage device(s) 540, and the interface(s) 550 are interconnected using a system bus 560. The processor(s) 520 are capable of processing instructions for execution within the computing device 510, and can include one or more single-threaded and/or multi-threaded processors. The processor(s) 520 are capable of processing instructions stored in the memory device(s) 530 and/or on the storage device(s) 540. The memory device(s) 530 can store data within the computing device 510, and can include one or more computer-readable media, volatile memory units, and/or non-volatile memory units. The storage device(s) 540 can provide mass storage for the computing device 510, can include various computer-readable media (e.g., a floppy disk device, a hard disk device, a tape device, an optical disk device, a flash memory or other similar solid state memory device, or an array of devices, including devices in a storage area network or other configurations), and can provide date security/encryption capabilities.

The interface(s) 550 can include various communications interfaces (e.g., USB, Near-Field Communication (NFC), Bluetooth, WiFi, Ethernet, wireless Ethernet, etc.) that can be coupled to the network(s) 570, peripheral device(s) 580, and/or data source(s) 590 (e.g., through a communications port, a network adapter, etc.). Communication can be provided under various modes or protocols for wired and/or wireless communication. Such communication can occur, for example, through a transceiver using a radio-frequency. As another example, communication can occur using light (e.g., laser, infrared, etc.) to transmit data. As another example, short-range communication can occur, such as using Bluetooth, WiFi, or other such transceiver. In addition, a GPS (Global Positioning System) receiver module can provide location-related wireless data, which can be used as appropriate by device applications. The interface(s) 550 can include a control interface that receives commands from an input device (e.g., operated by a user) and converts the commands for submission to the processors 520. The interface(s) 550 can include a display interface that includes circuitry for driving a display to present visual information to a user. The interface(s) 550 can include an audio codec which can receive sound signals (e.g., spoken information from a user) and convert it to usable digital data. The audio codec can likewise generate audible sound, such as through an audio speaker. Such sound can include real-time voice communications, recorded sound (e.g., voice messages, music files, etc.), and/or sound generated by device applications.

The network(s) 570 can include one or more wired and/or wireless communications networks, including various public and/or private networks. Examples of communication networks include a LAN (local area network), a WAN (wide area network), and/or the Internet. The communication networks can include a group of nodes (e.g., computing devices) that are configured to exchange data (e.g., analog messages, digital messages, etc.), through telecommunications links. The telecommunications links can use various techniques (e.g., circuit switching, message switching, packet switching, etc.) to send the data and other signals from an originating node to a destination node. In some implementations, the computing device 510 can communicate with the peripheral device(s) 580, the data source(s) 590, and/or other computing devices over the network(s) 570. In some implementations, the computing device 510 can directly communicate with the peripheral device(s) 580, the data source(s), and/or other computing devices.

The peripheral device(s) 580 can provide input/output operations for the computing device 510. Input devices (e.g., keyboards, pointing devices, touchscreens, microphones, cameras, scanners, sensors, etc.) can provide input to the computing device 510 (e.g., user input and/or other input from a physical environment). Output devices (e.g., display units such as display screens or projection devices for displaying graphical user interfaces (GUIs)), audio speakers for generating sound, tactile feedback devices, printers, motors, hardware control devices, etc.) can provide output from the computing device 510 (e.g., user-directed output and/or other output that results in actions being performed in a physical environment). Other kinds of devices can be used to provide for interactions between users and devices. For example, input from a user can be received in any form, including visual, auditory, or tactile input, and feedback provided to the user can be any form of sensory feedback (e.g., visual feedback, auditory feedback, or tactile feedback).

The data source(s) 590 can provide data for use by the computing device 510, and/or can maintain data that has been generated by the computing device 510 and/or other devices (e.g., data collected from sensor devices, data aggregated from various different data repositories, etc.). In some implementations, one or more data sources can be hosted by the computing device 510 (e.g., using the storage device(s) 540). In some implementations, one or more data sources can be hosted by a different computing device. Data can be provided by the data source(s) 590 in response to a request for data from the computing device 510 and/or can be provided without such a request. For example, a pull technology can be used in which the provision of data is driven by device requests, and/or a push technology can be used in which the provision of data occurs as the data becomes available (e.g., real-time data streaming and/or notifications). Various sorts of data sources can be used to implement the techniques described herein, alone or in combination.

In some implementations, a data source can include one or more data store(s) 590a (e.g., databases, or other sorts of data management systems). The data store(s) can be provided by a single computing device or network (e.g., on a file system of a server device) or provided by multiple distributed computing devices or networks (e.g., hosted by a computer cluster, hosted in cloud storage, etc.). In some implementations, a database management system (DBMS) can be included to provide access to data contained in database(s) (e.g., through the use of a query language and/or application programming interfaces (APIs)). The database(s), for example, can include relational databases, object databases, structured document databases, unstructured document databases, graph databases, and other appropriate types of databases.

In some implementations, a data source can include one or more blockchains 590b. A blockchain can be a distributed ledger that includes blocks of records that are securely linked by cryptographic hashes. Each block of records includes a cryptographic hash of the previous block, and transaction data for transactions that occurred during a time period. The blockchain can be hosted by a peer-to-peer computer network that includes a group of nodes (e.g., computing devices) that collectively implement a consensus algorithm protocol to validate new transaction blocks and to add the validated transaction blocks to the blockchain. By storing data across the peer-to-peer computer network, for example, the blockchain can maintain data quality (e.g., through data replication) and can improve data trust (e.g., by reducing or eliminating central data control).

In some implementations, a data source can include one or more machine learning systems 590c. The machine learning system(s) 590c, for example, can be used to analyze data from various sources (e.g., data provided by the computing device 510, data from the data store(s) 590a, data from the blockchain(s) 590b, and/or data from other data sources), to identify patterns in the data, and to draw inferences from the data patterns. In general, training data 592 can be provided to one or more machine learning algorithms 594, and the machine learning algorithm(s) can generate a machine learning model 596. Execution of the machine learning algorithm(s) can be performed by the computing device 510, or another appropriate device. Various machine learning approaches can be used to generate machine learning models, such as supervised learning (e.g., in which a model is generated from training data that includes both the inputs and the desired outputs), unsupervised learning (e.g., in which a model is generated from training data that includes only the inputs), reinforcement learning (e.g., in which the machine learning algorithm(s) interact with a dynamic environment and are provided with feedback during a training process), or another appropriate approach. A variety of different types of machine learning techniques can be employed, including but not limited to convolutional neural networks (CNNs), deep neural networks (DNNs), recurrent neural networks (RNNs), and other types of multi-layer neural networks. With respect to the technology described herein, the training data can include data that represents a use of operation handlers by a data operation platform when performing multi-stage data operations. The machine learning model that results from the machine learning algorithm(s) can be used to predict a number of operation handlers to be employed by the data operation platform at various times. Use of the machine learning model can provide the benefit of improved load balancing with respect to the operation handlers.

Various implementations of the systems and techniques described herein can be realized in digital electronic circuitry, integrated circuitry, specially designed ASICs (application specific integrated circuits), computer hardware, firmware, software, and/or combinations thereof. A computer program product can be tangibly embodied in an information carrier (e.g., in a machine-readable storage device), for execution by a programmable processor. Various computer operations (e.g., methods described in this document) can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, by a computer to perform a certain activity or bring about a certain result. A computer program can be written in any form of programming language, including compiled or interpreted languages, and can be deployed in any form, including as a stand-alone program or as a module, component, subroutine, or other unit suitable for use in a computing environment. A computer program product can be a computer-or machine-readable medium, such as a storage device or memory device. As used herein, the terms machine-readable medium and computer-readable medium refer to any computer program product, apparatus and/or device (e.g., magnetic discs, optical disks, memory, etc.) used to provide machine instructions and/or data to a programmable processor, including a machine-readable medium that receives machine instructions as a machine-readable signal. The term machine-readable signal refers to any signal used to provide machine instructions and/or data to a programmable processor.

Suitable processors for the execution of a program of instructions include, by way of example, both general and special purpose microprocessors, and can be a single processor or one of multiple processors of any kind of computer. Generally, a processor will receive instructions and data from a read-only memory or a random access memory or both. The elements of a computer are a processor for executing instructions and one or more memory devices for storing instructions and data. Generally, a computer can also include, or can be operatively coupled to communicate with, one or more mass storage devices for storing data files. Such devices can include magnetic disks (e.g., internal hard disks and/or removable disks), magneto-optical disks, and optical disks. Storage devices suitable for tangibly embodying computer program instructions and data can include all forms of non-volatile memory, including by way of example semiconductor memory devices, flash memory devices, magnetic disks (e.g., internal hard disks and removable disks), magneto-optical disks, and optical disks. The processor and the memory can be supplemented by, or incorporated in, ASICs (application-specific integrated circuits).

The systems and techniques described herein can be implemented in a computing system that includes a back end component (e.g., a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). The computer system can include clients and servers, which can be generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

1. A computer method for chaining data operations, comprising:
receiving, from a client device, a definition of a multi-stage data operation that is expressed in a user-facing syntax;
translating the user-facing syntax of the multi-stage data operation into a definition of the multi-stage data operation that is expressed in an intermediate syntax;
parsing, by a data processing platform, the intermediate syntax of the multi-stage data operation, to identify a series of data operations included in the multi-stage data operation;
coordinating, by the data processing platform, execution of the series of data operations included in the multi-stage data operation, by:
for each data operation in the series of data operations:
selecting, by the data processing platform, a respective operation handler that is configured to execute the data operation;
generating, by the data processing platform, domain-specific syntax that is used by the selected operation handler for executing the data operation; and
providing, by the data processing platform and to the selected operation handler, the domain-specific syntax for executing the data operation;
for a first data operation and a second data operation in the series of data operations:
in response to determining that neither the first data operation nor the second data operation depend on input from another data operation, (i) identifying a first output variable that indicates output of the first data operation, and (ii) identifying a second output variable that indicates output of the second data operation;
mapping, by the data processing platform, (i) a first portion of a data cache to the first output variable for storing first operation results data that results from execution of the first data operation, and (ii) a second portion of the data cache to the second output variable for storing second operation results data that results from execution of the second data operation; and
coordinating a concurrent execution of the first data operation and the second data operation; and
for a third data operation in the series of data operations:
in response to identifying a first input variable that indicates input for the third data operation and that corresponds to the first output variable of the first data operation, and identifying a second input variable that indicates input for the third data operation and that corresponds to the second output variable of the second data operation, waiting for availability of the first operation results data and the second operation results data;
retrieving, by the data processing platform, (i) the first operation results data from the first portion of the data cache that is mapped to the first input variable, and (ii) the second operation results data from the second portion of the data cache that is mapped to the second input variable, and
providing the retrieved first operation results data and the retrieved second operation results data to its operation handler; and
after all data operations in the series of data operations have been successfully executed, providing a result of the multi-stage data operation to the client device.

2. The computer-implemented method of claim 1, wherein the intermediate syntax is formatted as an abstract syntax tree.

3. The computer-implemented method of claim 2, wherein parsing the definition of the multi-stage data operation comprises traversing nodes of the abstract syntax tree, wherein each operation is defined in a respective node of the abstract syntax tree.

4. The computer-implemented method of claim 1, wherein mapping a given portion of the data cache to a given output variable comprises:
generating a cache key that references the given portion of the data cache; and
maintaining an association between the cache key and the given output variable.

5. The computer-implemented method of claim 1, wherein the translating of the user-facing syntax is performed at the client device.

6. The computer-implemented method of claim 1, wherein the translating of the user-facing syntax is performed by the data processing platform.

7. The computer-implemented method of claim 1, wherein at least two of the operation handlers are configured to execute data operations on different data platforms.

8. The computer-implemented method of claim 1, wherein at least two of the operation handlers are configured to execute different types of data operations on a same data platform.

9. The computer-implemented method of claim 1, further comprising:
receiving, by the data processing platform from a given operation handler, operation results data that results from execution of a given data operation; and
storing the operation results data, by the data processing platform and in a given portion of the data cache that corresponds to a given output variable.

10. The computer-implemented method of claim 1, wherein a given operation handler is configured to store results data that results from execution of a given data operation, in a given portion of the data cache that corresponds to a given output variable.

11. The computer-implemented method of claim 1, further comprising:
receiving, by the data processing platform, a set of execution parameters in association with the multi-stage data operation, wherein the set of execution parameters includes, for at least one data operation of the multi-stage data operation, a number of retries for the data operation;
for the at least one data operation in the series of data operations, receiving, from a given operation handler, a notification that execution of the at least one data operation has failed; and
in response to receiving the notification, providing, by the data processing platform, an instruction to re-execute the at least one data operation.

12. The computer-implemented method of claim 1, wherein coordinating execution of the series of data operations included in the multi-stage data operation comprises:
maintaining a state object that tracks a current status of the data operations in the series of data operations; and
providing the client device with access to the state object.

13. The computer-implemented method of claim 1, wherein a given operation handler is selected from a pool of idle operation handlers that are configured to execute the given data operation.

14. The computer-implemented method of claim 13, further comprising:
tracking a number of idle operation handlers over time, and (i) increasing a number of active operation handlers in response to the number of idle operation handlers being fewer than a minimum threshold number, or (ii) decreasing the number of active operation handlers in response to the number of idle operation handlers being greater than a maximum threshold number.

15. A computer system for chaining data operations, comprising:
one or more data processing apparatuses including one or more processors, memory, and storage devices storing instructions that, when executed, cause the one or more processors to perform operations comprising:
receiving, from a client device, a definition of a multi-stage data operation that is expressed in a user-facing syntax;
translating the user-facing syntax of the multi-stage data operation into a definition of the multi-stage data operation that is expressed in an intermediate syntax;
parsing, by a data processing platform, the intermediate syntax of the multi-stage data operation, to identify a series of data operations included in the multi-stage data operation;
coordinating, by the data processing platform, execution of the series of data operations included in the multi-stage data operation, by:
for each data operation in the series of data operations:
selecting, by the data processing platform, a respective operation handler that is configured to execute the data operation;
generating, by the data processing platform, domain-specific syntax that is used by the selected operation handler for executing the data operation; and
providing, by the data processing platform and to the selected operation handler, the domain-specific syntax for executing the data operation;
for a first data operation and a second data operation in the series of data operations:
in response to determining that neither the first data operation nor the second data operation depend on input from another data operation, (i) identifying a first output variable that indicates output of the first data operation, and (ii) identifying a second output variable that indicates output of the second data operation;
mapping, by the data processing platform, (i) a first portion of a data cache to the first output variable for storing first operation results data that results from execution of the first data operation, and (ii) a second portion of the data cache to the second output variable for storing second operation results data that results from execution of the second data operation; and
coordinating a concurrent execution of the first data operation and the second data operation; and
for a third data operation in the series of data operations:
in response to identifying a first input variable that indicates input for the third data operation and that corresponds to the first output variable of the first data operation, and identifying a second input variable that indicates input for the third data operation and that corresponds to the second output variable of the second data operation, waiting for availability of the first operation results data and the second operation results data;
retrieving, by the data processing platform, (i) the first operation results data from the first portion of the data cache that is mapped to the first input variable, and (ii) the second operation results data from the second portion of the data cache that is mapped to the second input variable, and
providing the retrieved first operation results data and the retrieved second operation results data to its operation handler; and
after all data operations in the series of data operations have been successfully executed, providing a result of the multi-stage data operation to the client device.

16. The computer system of claim 15, the operations further comprising:
receiving, by the data processing platform from a given operation handler, operation results data that results from execution of a given data operation; and
storing the operation results data, by the data processing platform and in a given portion of the data cache that corresponds to a given output variable.

17. The computer system of claim 15, wherein a given operation handler is configured to store results data that results from execution of a given data operation, in a given portion of the data cache that corresponds to a given output variable.

18. The computer system of claim 15, the operations further comprising:
receiving, by the data processing platform, a set of execution parameters in association with the multi-stage data operation, wherein the set of execution parameters includes, for at least one data operation of the multi-stage data operation, a number of retries for the data operation;
for the at least one data operation in the series of data operations, receiving, from a given operation handler, a notification that execution of the at least one data operation has failed; and
in response to receiving the notification, providing, by the data processing platform, an instruction to re-execute the at least one data operation.

19. The computer system of claim 15, wherein coordinating execution of the series of data operations included in the multi-stage data operation comprises:
maintaining a state object that tracks a current status of the data operations in the series of data operations; and
providing the client device with access to the state object.

20. The computer system of claim 15, wherein a given operation handler is selected from a pool of idle operation handlers that are configured to execute the given data operation.
